(19) United States
(12) Patent Application Publication
(10) Pub. No.: US 2016/0205917 A1
(43) Pub. Date: Jul. 21, 2016

(54) WEED ERADICATION METHOD AND APPARATUS

(71) Applicant: Elwha LLC, Bellevue, WA (US)

(72) Inventors: Alistair K. Chan, Bainbridge Island, WA (US); William D. Duncan, Mill Creek, WA (US); Phillip A. Eckhoff, Kirkland, WA (US); Roderick A. Hyde, Redmond, WA (US); Jordin T. Kare, San Jose, CA (US); Keith D. Rosema, Olympia, WA (US); Lowell L. Wood,, Jr., Bellevue, WA (US)

(73) Assignee: Elwha LLC, Bellevue, WA (US)

(21) Appl. No.: 14/598,068

(22) Filed: Jan. 15, 2015

(51) Int. Cl. A01M 21/04; G21K 5/04

(52) U.S. Cl. CPC A01M 21/04; G21K 5/04

(57) ABSTRACT

A plant material targeting apparatus includes a light source platform that is mobile during a non-use state and is at a fixed location during a use state. The apparatus also includes a light source coupled to the light source platform. The light source is configured to provide a high-intensity light. The apparatus further includes a beam director configured to direct the high-intensity light at first and second plant material targets. The apparatus also includes a control system configured to receive information representative of the location of the plant material target. The control system is also configured to provide a control signal to the beam director to control aiming of the high-intensity light at each of the first and second plant material targets while the light source platform is at the fixed location.

### CROSS-REFERENCE TO RELATED APPLICATION

This application is related to U.S. application Ser. No. ______, (Attorney Docket No. 103315-0268), titled “WEED ERADICATION METHOD AND APPARATUS HAVING LIGHT REDIRECTOR,” filed Jan. 15, 2015, which is incorporated herein by reference in its entirety.

### BACKGROUND

In commercial environments, weeds can outgrow useful crops, thereby stealing water and nutrients meant for the crops. Some weeds may also grow tall enough to obstruct light from crops, and their height further enables their seedpods to be unobstructed when they burst, thereby allowing the seeds to be wind-cast over large areas. As a result, weeds may not merely negatively affect a farmer's productivity every year, but may potentially, if left unchecked, completely overwhelm a field.

Weed control accounts for, in many instances, a large proportion (e.g., up to approximately 30%) of the cost of growing crops. Selective physical destruction of weeds is effective but highly labor intensive. Bulk physical destruction (e.g., plowing) is not always feasible (e.g., due to an existing crop) and may be destructive to soils (e.g., by causing erosion). Various chemicals (e.g., herbicides) are also often used to control weeds. However, chemical means to kill and control weeds are not a panacea. For example, resistance to frequently used herbicides is growing. In addition, a large segment of the market prefers non-chemically treated (e.g., “certified organic”) crops.

### SUMMARY

One embodiment relates to a plant material targeting apparatus. The plant material targeting apparatus includes a light source platform that is mobile during a non-use state and is at a fixed location during a use state. The apparatus also includes a light source coupled to the light source platform. The light source is configured to provide a high-intensity light. The apparatus further includes a beam director configured to direct the high-intensity light at first and second plant material targets. The apparatus also includes a control system configured to receive information representative of the location of the plant material target. The control system is also configured to provide a control signal to the beam director to cause the aiming of the high-intensity light at each of the first and second plant material targets while the light source platform is at the fixed location.

Another embodiment relates to a method of eradicating unwanted plants. The method includes identifying locations of first and second plant material targets. The method also includes positioning, during a first non-use state, a light source platform including a high-intensity light source, at a first position within a crop field based on the location of the plant material targets. The method further includes directing, by the beam director during a first use state, a first high-intensity light from the high-intensity light source toward the first plant material target. The first use state follows the first non-use state. Further yet, the method includes directing, by the beam director during the first use state, a second high-intensity light from the high-intensity light source toward the second plant material target. Still further, the method includes receiving a control signal by the light source. The control signal is based on the location of the plant material target. The method also includes positioning, during a second non-use state, the light source platform including the high-intensity light source, at a second position. The second non-use state follows the first use state.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic of a plant material targeting apparatus according to one embodiment.

FIG. 2 is a schematic of a plant material targeting apparatus according to another embodiment.

FIG. 3 is a schematic of a plant material targeting apparatus according to another embodiment.

FIG. 4 is a schematic of a plant material targeting apparatus according to another embodiment.

FIG. 5 is a block diagram of a control system for a plant material targeting apparatus according to one embodiment.

FIG. 6 is a schematic of a plant material targeting apparatus according to another embodiment.

FIG. 7 is a flow diagram of a method of eradicating and controlling weeds according to one embodiment.

FIG. 8 is a flow diagram of a method of eradicating and controlling weeds according to another embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Weed control is an essential part of all agricultural systems, including food crop (e.g., corn, maize, soybeans, silage, wheat, oats, rye, barley, flax, oilseed, fiber, vegetables, fruit, nuts, seeds, etc.), non-food crop (e.g., flowers, ornamental plants, etc.), and non-crop (e.g., native and non-native decorative plants, etc.) production systems. Unwanted plants (e.g., weeds) reduce yields by competing with crops and non-crop plants for water, nutrients, and sunlight, and may directly reduce profits by hindering harvest operations, lowering crop quality, and producing chemicals which are harmful to plants (e.g., via allelopathy). Left uncontrolled, weeds may harbor insects and diseases and produce seed or rootstocks which infest the field and affect future crops. Despite large expenditures for weed control, it is estimated that losses in U.S. crops due to weeds left uncontrolled exceed $8 Billion annually.

Therefore, it is desirable to control and/or eradicate weeds in fields. Control generally involves attacking the weeds in such a way as to prevent the weeds from competing with the crops for sunlight, water, nutrients, and other resources. Eradication generally refers to the removal of weeds and/or weed seeds from a field so that the weeds will not reemerge year-over-year unless they are reintroduced to the field. Weeds may be eradicated in various ways, such as by consistently preventing a buildup of weed seed in the soil, particularly new weeds whose seeds are not already in the soil. As used herein, “crops” refer to desirable (e.g., planted) species and “weeds” refer to undesirable (e.g., non-planted) species.

The ultimate goal regarding weed control is a long-term reduction in the reappearance of weeds. It may therefore be beneficial to use various advanced weed control mechanisms, such as high resolution, minimal mechanical, optical, chemical or biological means, or some combination thereof, to control weeds. One approach may be to kill and re-kill, or damage and re-damage the weeds, in some regular manner, to help prevent a generation of weeds from successfully reproducing.

Cost, although always a consideration, may not necessarily be a limiting factor, because the treatment may only be needed once or twice a year and may therefore allow cost-sharing between many fields and/or customers. Additionally, as crop prices have risen significantly in recent years, incremental improvements in yield and crop quality may more significantly affect farmers' profits.

The present disclosure is directed to apparatus and methods to eradicate undesirable plants, such as weeds. In some embodiments, high-intensity light sources (e.g., a laser or an array of lasers, which may be coherent or incoherent) may allow long-range (e.g., a kilometer or further) killing or damaging of plant material using manageable apertures (e.g., 30 cm or smaller for visible or near-infrared light). Using these ranges, it may be desirable to assemble a system that enables high-intensity light sources to be stationed (e.g., temporarily, semi-permanently, or permanently) along the border of a field to target weeds. Such a light source would have sufficient intensity capable of killing or damaging a plant material target whether it be the leaves, the stems, the flowers, the root ball, the seedpods, or other portions. In certain embodiments, modern laser firing control methodologies such as inertial platforms, laser ranging, real-time imaging and/or remote sensing, and the like are used.

In addition to a high-intensity light source, some embodiments utilize, separately or simultaneously, other techniques to kill or damage plant material targets. For example, some embodiments utilize chemicals such as herbicides, which may be delivered to certain plant material targets (e.g., seedpods) in addition to or instead of the high-intensity light source. For example, certain weeds may be too large to efficiently kill using a high-intensity light source. Accordingly, the system may apply an herbicide to the weed as a complimentary, alternative, or redundant means to kill or damage the weed. In certain embodiments, certain herbicides are chemically tailored for seed killing in particular. Other embodiments utilize mechanical systems (e.g., cultivators), electrical systems, and/or thermal systems in separately from or simultaneous with the high-intensity light source.

In some embodiments, manned or unmanned vehicles (e.g., unmanned aircraft vehicles (UAVs) or unmanned ground vehicles, such as wheeled or tracked vehicles, stilted walking vehicles, ground-scurrying vehicles, etc.), robots, and/or other light-weight transportable systems are configured to perform various tasks in addition to or other than weed control and eradication. For example, some embodiments employ plant identification/health vehicles and/or robots to mark plants for eradication and/or other actions (e.g. insect/pest control). Other embodiments may include vehicles and/or robots to disperse fertilizer or seeds. Further embodiments may utilize any of various types of sensors to collect data regarding plants and/or the surrounding environment. For the purposes of the present disclosure, the term “vehicle” may include any type of object capable of carrying an item (e.g., a light redirector, a light source, a sensor, etc.), and the term “robot” may include any type of machine capable of automatically or semi-automatically carrying out a series of actions. Therefore, in some circumstances, an object may be both a vehicle and a robot.

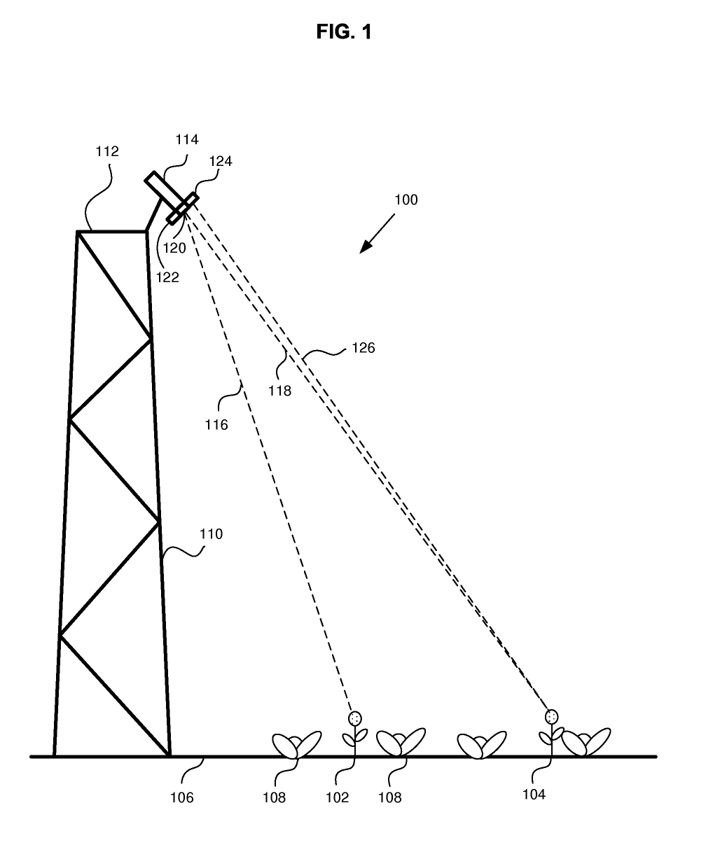

Several alternative embodiments of plant material targeting apparatus are illustrated in FIGS. 1-6. The plant material targeting apparatus of FIGS. 1-6 is used to eradicate and control plant material target 102 or other plants on the ground such as in field 106 or other area having crops 108 or other desirable plants. Plant material target 102 may include a weed or a specific portion of a weed (e.g., a seed pod). In some embodiments, the plant material targeting apparatus may use short-range killing techniques from a mobile ground vehicle. In other embodiments, the plant material targeting apparatus may use long-range killing techniques (e.g., high-intensity light beams) from a fixed or mobile (e.g., via air or ground) platform.

For the sake of clarity and brevity, various embodiments are described herein with respect to high-intensity light sources and high-intensity light beams. However, the high-intensity light sources may include various types of light sources. The high-intensity light source may be configured to emit at least one of visible light, infrared light, and ultraviolet light. In some embodiments, even longer wavelengths of electromagnetic radiation (e.g. microwave, millimeter or submillimeter radiation) which can be transmitted through the air and reflected and focused by suitable quasi-optical elements may be used in place of UV, visible, and/or infrared light. The high-intensity light source may include a laser or a laser array. The laser or laser array may include a diode laser, a carbon dioxide (CO₂) laser, a fiber laser, a diode-pumped solid state (DPSS) laser, or other types of lasers. In some embodiments, the light source includes a quasi-optical source (e.g., a source configured to produce waves having a frequency of between 0.3 and 3 terahertz and a wavelength of between 1 mm and 1 μm). In some embodiments, the light source includes optics, such as a beam expander, for transmitting the light beam to the redirector platform. In some embodiments, the light source includes a light concentrator and/or an incoherent light collector not enabled for redirection. In some embodiments, the focused light may damage or destroy plant material by localized heating. In other embodiments, plant material may be damaged or destroyed by other photophysical or photochemical effects, such as bleaching, for example.

Referring now to FIG. 1, plant material targeting apparatus 100 is illustrated, according to an embodiment. Plant material targeting apparatus 100 may be used to eradicate and control plant material targets 102, 104 (e.g., weeds) in field 106 having crops 108. In one embodiment, apparatus 100 includes light source platform structure 110. Light source platform structure 110 is configured to support light source platform 112 holding high-intensity light source 114 (e.g., laser source). In some embodiments, structure 110 and light source platform 112 are moved, placed, and/or erected outside of field 106 (e.g., outside of a crop growing area of field 106) or alternatively at various locations within field 106 (e.g., within a crop growing area of field 106) or other area of interest. High-intensity light source 114 is configured to provide high-intensity light beams 116, 118 (e.g., laser beams), which may be directed (e.g., aimed) at plant material targets 102, 104. Structure 110 provides sufficient height to high-intensity light source 114, which is able to provide high-intensity light beams 116, 118 directly onto at least a portion of plant material targets 102, 104.

Plant material targeting apparatus 100 may also include beam director 120 coupled to an output of high-intensity light source 114. According to an embodiment, beam director 120 is configured to direct the high-intensity light beams 116, 118 at plant material targets 102, 104. In some embodiments, high-intensity light source 114 includes a high-intensity light generating device and beam director 120 includes a high-intensity light delivery device. High-intensity light source 114 and beam director 120 may be encompassed in a common light source device or may be discrete components. For example, in some embodiments, high-intensity light source 114 may at least partially include a fiber optic cable and/or may be positioned off of light source platform 112.

Beam director 120 may include various types of optics (e.g., mirrors and lenses) to modify light beams 116, 118 and/or to direct the light beams 116, 118 at plant material targets 102, 104. In one embodiment, beam director 120 includes a single positionable mirror. In another embodiment, beam director 120 includes a mirror train including multiple positionable mirrors. In some embodiments, beam director 120 includes optics, such as lenses and/or mirrors (e.g., curved mirrors), to modify light beams 116, 118. For example, optics may be used to capture light beam 116, 118 and reduce or expand a diameter of light beams 116, 118. In various embodiments, optics are used to focus light beams 116, 118 to a small diameter to concentrate the energy of light beams 116, 118 to a small target.

In some embodiments, apparatus 100 may also include sensor 122 configured to provide information representative of plant material targets 102, 104 via high resolution imaging and/or remote sensing. In some embodiments, sensors 122 are configured to employ various imaging and/or remote sensing techniques (e.g., multi-spectral or spectrometric techniques) to provide information representative of plant material targets 102, 104. Such information may be utilized to control and/or assess eradication (e.g., via phenotyping) before, during, and after a treatment of an area. The assessment may provide knowledge about the effectiveness of the control and/or eradication treatment. In addition, the assessment may indicate where re-treatment may be necessary.

Sensor 122 may be configured to operate in a fixed position or may be movable. As illustrated in FIG. 1, sensor 122 is coupled to high-intensity light source 114. In other embodiments, sensor 122 is coupled to light source structure 110 or light source platform 112 or other structures. In further embodiments, one or more sensors 122 are coupled to one or more moving vehicle separate from light source platform 112, such as unmanned aerial vehicles (UAVs), close-to-ground robots, and/or other vehicles. In some embodiments, multiple sensors 122 or arrays of sensors 122 are utilized.

High resolution imaging and/or remote sensing performed by sensor 122, for example, may be used to distinguish plant material targets 102, 104 from crops 108 on a plant-by-plant basis, and to localize plant material targets 102, 104 at high (e.g., centimeter-level) accuracy. Sensor 122, combined with suitable analysis software, may distinguish between plant material targets 102, 104 and crops 108 based on, for example, size, shape, location, and color of overall plants or specific parts (e.g., leaves or seed pods) of plants. Sensor 122 may include any of various types of sensing devices, such as a camera, which may include an image recognition system. In some embodiments, sensor 122 includes a spectral sensor, which may include, for example, a multi-band sensor and/or a spectrometer. Multi-spectral or hyperspectral imaging techniques, or non-imaging spectrometry plus conventional imaging, may be used to provide additional information, particularly with respect to the health and condition of plants or plant parts such as seedpods. Spectrometric techniques may be passive (e.g., using available light) or active (using a separate light source to illuminate the object). It may also be beneficial to use such techniques to identify and localize the seedpods of plant material targets 102, 104 and to further identify their age to determine when the seedpods are mature enough to burst and sow the seeds of the next generation of plant material targets 102, 104.

Sensor 122 may be used in conjunction with satellite navigation systems. Modern farms often use satellite navigation systems, such as the Global Positioning System (GPS), the Global Navigation Satellite System (GLONASS), and/or local precision navigation systems to control planting, harvesting, and other farming operations. Therefore, in some embodiments, it is desirable to register the coordinates of planted crops 108 on a map. By doing so, the task of identifying at least some of plant material targets 102, 104 becomes much simpler because the locations of the crops 108 are known in advance. For example, sensor 122 may analyze locations of plant material targets 102, 104 relative to known locations of crops 108. Sensor 122 may also avoid keep-out areas where crops 108 are expected.

In some embodiments, apparatus 100 includes illumination source 124 configured to provide illumination beam 126 to illuminate potential plant material targets 102, 104. In general, illumination can be passive (e.g., configured for wavelength-dependent reflectivity and/or absorption) or can be active (e.g., configured to vaporize or excite part of the plant and observe the results). High-intensity light source 114 and illumination source 124 may be may be incorporated in the same device or in different devices and/or optical systems. For example, in an embodiment, high-intensity light source 114 includes a laser and the illumination source 124 includes a white light source.

In some embodiments, illumination (e.g., laser illumination) can be used for aimpoint control. For example, aimpoint control may include scanning illumination beam 126 (e.g., a low-intensity beam) and firing high-intensity light beam 118 (e.g., a high-intensity kill beam) when a target (e.g., plant material target 104) is identified. Aimpoint control may also include varying the focus of low-intensity illumination beam 126, and firing high-intensity light beam 118 when a desired spot size is identified. In some embodiments, the illumination mode may be used for damage assessment. For example, damage assessment may be used to control ongoing or future firing. In other words, damage may be assessed while high-intensity light source 114 is being fired or between discrete firing events.

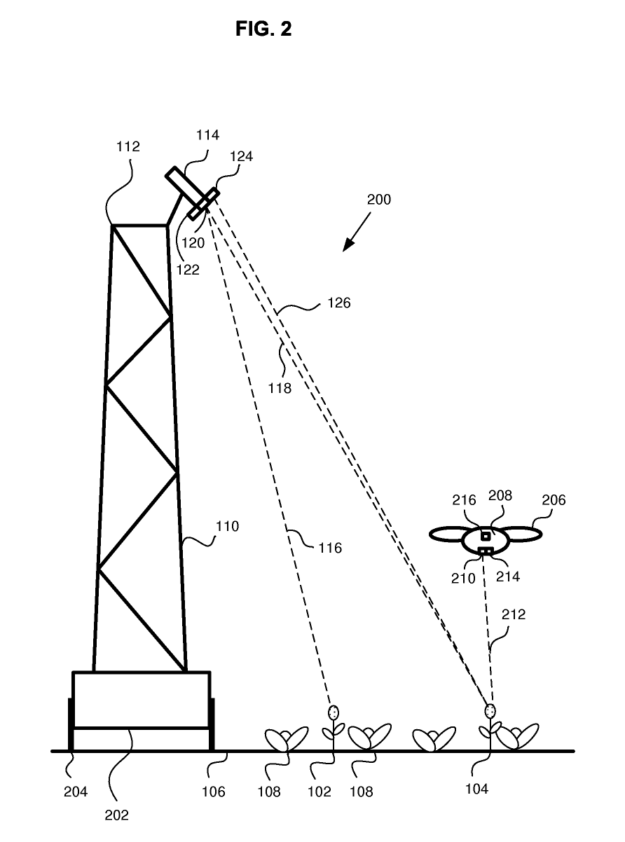

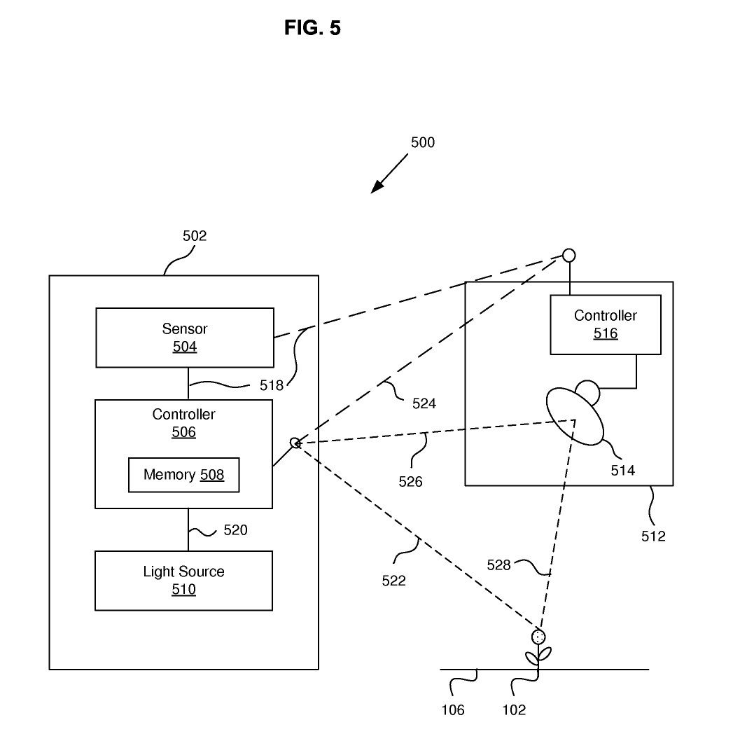

In some embodiments, one or more of light source structure 110, light source platform 112, light source 114, and beam director 120 are positionable (e.g., automatically, semi-automatically, and/or manually) via a control system (e.g., control system 500 of FIG. 5) to aim light beams 116, 118 at plant material targets 102, 104, based on information representative of plant material targets 102, 104 received from sensor 122. For example, light source structure 110 may be movable (e.g., positionable) within or outside of field 106, as described in further detail below in connection with FIG. 2. Light source platform 112 may be configured to be raised and lowered to change its height, and/or may be rotatable about one or more axes. Light source 114 may be rotatable or otherwise positionable about one or more axes. Beam director 120 may also be rotatable or otherwise positionable about one or more axes. Any of light source structure 110, light source platform 112, light source 114, and beam director 120 may be positionable independently or dependently with respect to any other of light source structure 110, light source platform 112, light source 114, and beam director 120. The control system may also control a shutter or optical switch to turn light beams 116, 118 on and off.

In some embodiments, the control system is configured to determine a type of plant material to target. For example, the control system may identify and distinguish crop 108 and plant material targets 102, 104. In addition, the control system may identify particular types of material on plant material targets 102, 104 to target, such as seedpods, leaves, and the like. Apparatus 100 may be used to kill plant material targets 102, 104 at specific times within a growth cycle, such as at first sprouting, at a set height, before seed release, and at other times.

In some embodiments, light source 114 is configured to be switchable between a use state and a non-use state. For example, light source 114 may be configured to provide high-intensity light beam 116 during the use state and to not provide high-intensity light beam during the non-use state. In some embodiments, light source 114 may cover or retract optical surfaces in the non-use state, and to expose optical surfaces only in the use state. In some embodiments, light source platform structure 110 is configured to be mobile during a non-use state and to remain in a fixed location during a use state, as described in further detail in connection with FIG. 2. Light source platform structure 110 may be capable of motion in lateral and longitudinal directions (e.g., to different areas within a field), as well as in a vertical direction. For example, in an embodiment, light source platform structure 110 is configured to cause a change in the height of light source platform 112 when switching from the non-use state to the use state. In further embodiments, light source platform 112 may include a mechanical stabilization system that is deployed during the use state but that is not used during the non-use state.

According to an embodiment, apparatus 100 may be configured to operate in a plant material damaging mode and in a plant material targeting mode. In the plant material damaging mode, high-intensity light source 114 may be configured to provide high-intensity light beams 116, 118 to plant material targets 102, 104 to cause damage (e.g., to kill) plant material targets 102, 104. In the plant material targeting mode, illumination source 124 may be configured to provide light for reasons other than killing plant material targets 102, 104. In one embodiment, apparatus 100 is configured to use illumination source 124 to first illuminate plant material targets 102, 104 and then to utilize high-intensity light source 114 to kill plant material targets 102, 104. In some embodiments, the plant material targeting mode is used for identification (e.g., via remote sensing, imaging, spectrometry, etc.) of plant material targets 102, 104. For example, the plant material targeting mode may be used to determine and store the location (e.g., in memory) of a plurality of plant material targets 102, 104 and to use the plant material damaging mode in accordance with the stored locations of the plant material targets 102, 104.

Turning to FIG. 2, plant material targeting apparatus 200 is illustrated according to one embodiment. Apparatus 200 is similar to apparatus 100 and may include, in various embodiments, components similar to those described above with respect to apparatus 100. In one embodiment, light source platform structure 110 is used to support platform 112 holding high-intensity light source 114 (e.g., laser source). In some embodiments, as illustrated in FIG. 2, light source 114 (e.g., via light source platform 112 and light source platform structure) is mobile. As used herein, the term “mobile” refers to devices being capable of being transported from one location to another location.

As illustrated in FIG. 2, structure 110 includes vehicle 202 with wheels 204 to allow platform 112 to be moved either within or outside of field 106. Vehicle 202 may include a wheeled or tracked vehicle (e.g., a tractor or a truck), a legged vehicle, a pedestal-walking vehicle, a cable-carried vehicle, etc. In some embodiments, vehicle 202 is self-propelled while in other embodiments, vehicle 202 is towed or otherwise transported, for example, by a tractor. In other embodiments, light source platform 112 is configured to be carried by a human or animal. In one embodiment, light source 114 is mounted to a tractor or to an implement pulled by a tractor. The implement may include multiple beam directors 120 positioned on a lateral boom. The beam directors 120 may be configured to receive multiple light beams 116, 118 from light source 114, and to direct light beams 116, 118 to various plant material targets 102, 104.

In one embodiment, apparatus 200 includes aircraft 206, which may be unmanned or manned. Aircraft 206 includes light source platform 208 and high-intensity light source 210 mounted to light source platform 208. High-intensity light source 208 may be configured to provide high-intensity light beam 212 to second plant material target 104 and other plant material targets. High-intensity light source 210 may operate in generally the same manner as high-intensity light source 114. According to various embodiments, aircraft 206 may be or include airplanes, kites, balloons, and the like, which may be manned, remotely piloted, or robotic. In some embodiments, aircraft 206 also includes illumination source 214, which may operate in a similar manner as illumination source 124 to illuminate potential plant material targets 102, 104. Aircraft 206 may also include sensor 216, which may operate in a similar manner as sensor 122 to provide information representative of plant material targets 102, 104. Weed identification, targeting, and fire control decisions may be made on-board or off-board aircraft 206.

In some embodiments, apparatus 200 is configured to direct high-intensity light (e.g., light beams 116, 118) toward more than one plant material targets 102, 104 before moving light source structure 110 and/or light source platform 112. For example, in one embodiment, apparatus 200 is configured to direct light beam 116 from light source 114 (e.g., via beam director 120) toward first plant material target 102. Apparatus 200 is then configured to direct light beam 118 toward second plant material target 104. Apparatus 200 may subsequently move light source structure 110 and/or light source platform 112 to another location or position to target other plant material targets.

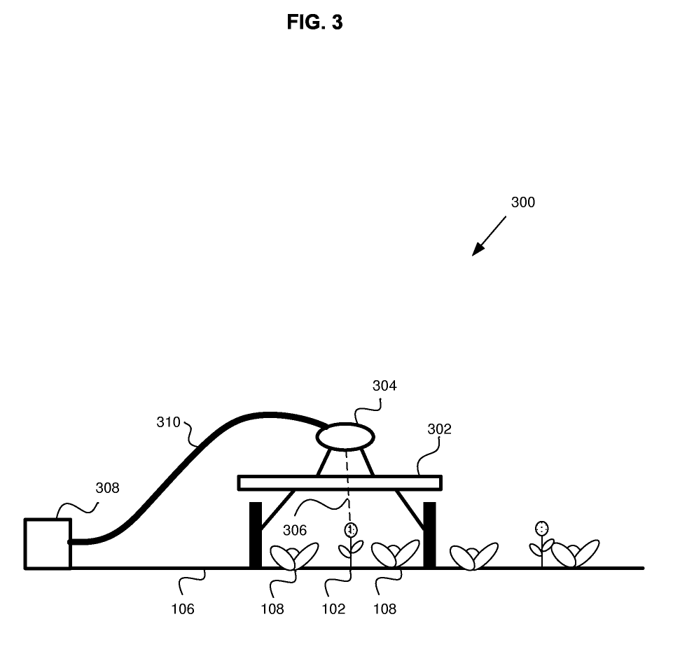

Turning to FIG. 3, plant material targeting apparatus 300 is illustrated according to one embodiment. Apparatus 300 is similar to apparatus 100, 200 in some aspects and may include, in various embodiments, components similar to those described above with respect to apparatus 100, 200. As illustrated in FIG. 3, apparatus 300 includes vehicle 302, which is configured to be mobile (e.g., moved, transported, or otherwise positioned) within or outside of field 106. Apparatus 300 also includes beam director 304 coupled to vehicle 302. Beam director 304 is configured to receive high-intensity light beam 306 from high-intensity light source 308, and to direct high-intensity light beam 306 towards plant material target 102. High-intensity light source 308 may be configured to provide high-intensity light beam 306 to beam director 304 via optical fiber or conduit 310. In other embodiments, light source 308 is configured to provide high-intensity light beam 306 to beam director 304 via free space or in other ways. In some embodiments, light source 308 is separate from vehicle 302, while in other embodiments, light source 308 is coupled to vehicle 302.

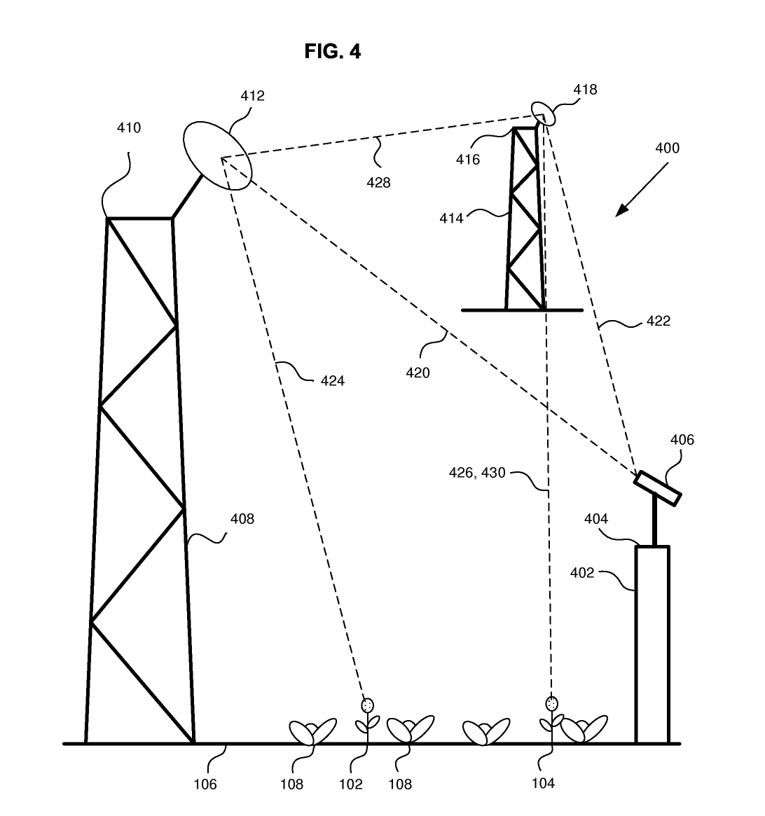

Turning to FIG. 4, plant material targeting apparatus 400 is illustrated according to one embodiment. Similar to apparatus 100, 200, 300 of FIGS. 1-3, apparatus 400 of FIG. 4 may operate in the presence of plant material targets 102, 104 and crops 108 in field 106. Apparatus 400 includes light source structure 402 including light source platform 404 configured to support high-intensity light source 406 (e.g., laser). Light source structure 402 is configured to be positioned in a fixed location, either outside of (e.g., near a perimeter of) field 106 or inside of (e.g., near the middle of) field 106.

Apparatus 400 also includes first beam director structure 408 including first beam director platform 410 configured to support first beam director 412. Apparatus 400 may also include second beam director structure 414 including second beam director platform 416 configured to support second beam director 418. In one embodiment, second beam director structure 414 is located in another field, which may be spaced far (e.g., up to 1 km or further) from light source structure 402 and/or first beam director structure 408. First and second beam directors 412, 418 may include optics as described in connection with beam director 120 of FIGS. 1 and 2. Any of first and second beam director structures 408, 414 may be located within or outside of field 106, and may be mobile or stationary. Any of light source structure 402, first beam director structure 408, and second beam director structure 414 may further include sensors (e.g., similar to sensor 122 of FIGS. 1 and 2) and illumination sources (e.g., similar to illumination source 124 of FIGS. 1 and 2).

According to an embodiment, high-intensity light source 404 is configured to provide high-intensity light beams 420, 422 to first and/or second beam directors 412, 418. First and second beam directors 412, 418 may be configured to redirect high-intensity light beams 420, 422 as redirected beams 424, 426 towards plant material targets 102, 104, respectively. In some embodiments, first beam director 412 is configured to redirect high-intensity light beam 420 as first redirected beam 428 towards second beam director 418, and second beam director 418 may be configured to redirect first redirected beam 428 as second redirected beam 430 towards plant material target 104. In some embodiments, high-intensity light beams 420, 422 and redirected beams 424, 426, 428, 430 may be delivered via a free-space link through the air. Redirection by first and second beam directors 412, 418 may or may not be accompanied by beam modification (focusing, defocusing, mode cleanup, aperturing, filtration, etc.).

In some embodiments, any of light source structure 402 and first and second beam director structures 408, 414 are mobile between firing events. In some embodiments, any of light source platform 404, first and second beam director platforms 410, 416, light source 406, and first and second beam directors 412, 418 are positionable (e.g., capable of rotation or translation, including changing height).

In an embodiment, first beam director structure 408 is configured to be positioned at an end of a row of field 106 and second beam director structure 414 is configured to travel along the row. First beam director 412 of first beam director structure 408 may be configured to receive light beam 420 from light source 406 and redirect light beam 420 as redirected beam 428 to second beam director 418. Redirected beam 428 may travel along the row at which first beam director structure 408 is positioned, and redirected beam 428 may be redirected by second beam director 418 as second redirected beam 430, directed toward plant material target 104. First beam director structure 408 may be configured to travel from row to row in field 106, while second beam director structure 414 is configured to travel along each respective row at which first beam director structure 408 is positioned.

In some embodiments, all or part of light source platform 404 and/or at least one of first and second beam director platforms 410, 416 are elevated. For example, in some embodiments, light source 406 is positioned near the ground and is configured to deliver light beams 420, 422, for example, via air, fiber, conduit, or other media, to one or more elevated beam directors, such as first and/or second beam directors 412, 418. In some embodiments, at least one of light source structure 402 and first and second beam director structures 408, 414 are also used for weed imaging and/or remote sensing, as well as identification. In other embodiments, light source 406 (e.g., via a control system) inputs targeting information from another source.

Turning to FIG. 5, a block diagram of control system 500 for a plant material targeting apparatus is illustrated, according to one embodiment. Control system 500 includes high-intensity light control system 502, which may include sensor 504, high-intensity light controller 506 including memory 508, and high-intensity light source 510. Control system 500 may also include beam director control system 512, which may include beam director 514 and beam director controller 516. Sensor 504 may be configured to distinguish plant material targets 102 from desired plant material and to identify the location of plant material targets (e.g., weed 102).

In some embodiments, memory 508 includes data relating to characteristics of one or more plants. Control system 500 may be configured to distinguish plant material target 102 from a predetermined plant material based on stored plant characteristics data. For example, plant material targets 102 (e.g., weed seedpods) may be identified by performing various image processing techniques, such as image recognition, spectrometry, among others, on information captured by sensor 504.

Control system 502, via sensor 504, may be configured to provide information 518 representative of the location of plant material target (e.g., plant material target 102) to high-intensity light source controller 506 and/or beam director controller 516. In some embodiments, controller 506 is configured to transmit control signal 520 to light source 510 to cause light source 510 to provide high-intensity light beam 522 to plant material target 102. Additionally or alternatively, high-intensity light controller 506 may be configured to transmit control signal 524 to beam director controller 516 to control the position of beam director 514 to cause high-intensity light beam 526 to be redirected as redirected light beam 528 towards plant material target 102. In one embodiment, sensor 504 includes a camera. In another embodiment, sensor 504 includes a camera and an image recognition system. In a further embodiment, sensor 504 includes a spectral filter of a multicolor camera.

In some embodiments, control system 500 is configured for a high intensity mode and a low intensity mode. For example, control system 500 may be configured to use the low intensity mode to determine and store the location of a multiplicity of plant material targets 102 and to use the high intensity mode to aim and fire the high-intensity laser at the stored locations of plant material targets 102. In another embodiment, control system 500 may switch between a targeting mode configured to achieve and confirm plant material target 102 and a damaging mode to attempt to damage plant material target 102. The damaging mode and the targeting mode may both use at least a part of control system 500 (e.g., a single beam direction system). In some embodiments, high-intensity light source 510 is used for the targeting mode and an illumination source (not shown) is used for the plant material damaging mode. Light source 510 and the illumination source may use at least some of the same beam optics.

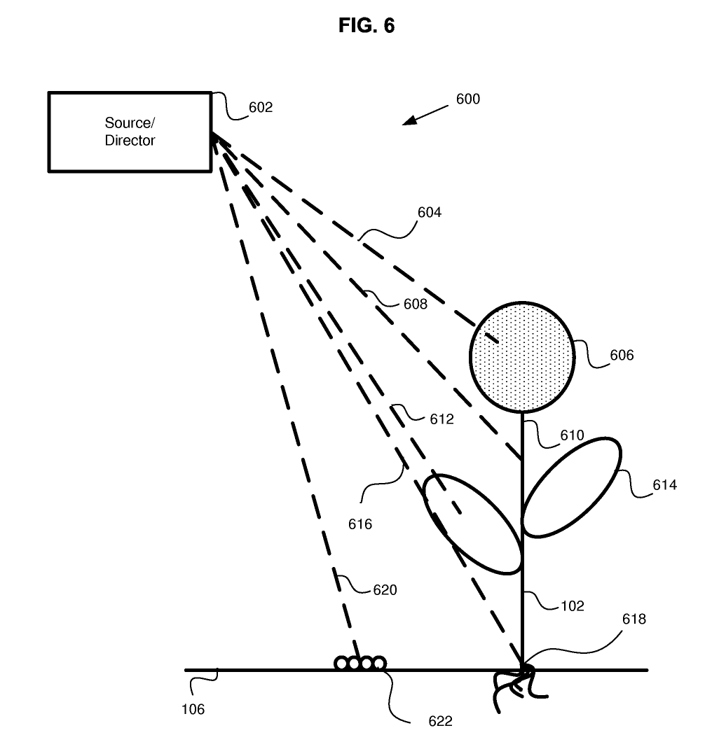

Turning to FIG. 6, plant material targeting apparatus 600 is illustrated according to one embodiment. Apparatus 600 is similar to apparatus 100, 200, 300 and 400, and 500 of FIGS. 1-5 and may include, in various embodiments, components similar to those described above with respect to apparatus 100, 200, 300, 400, and 500 of FIGS. 1-5. Apparatus 600 may include source/director 602 configured to identify and attack specific parts of plant material target 102. In some embodiments, source/director 602 identifies specific parts of plant material target 102 by image recognition, by spectrometry, or by other techniques. For example, according to various embodiments, source/director 602 may be configured to direct or redirect at least one of (1) beam 604 to seedpod 606 of plant material target 102; (2) beam 608 to stem 610 of plant material target 102; (3) beam 612 to leaves 614 of plant material target 102; (4) beam 616 to roots 618 of plant material target 102; and (5) beam 620 to detached seedpod 622 of plant material target 102. In addition, source/director 602 may be configured to kill plant material target 102 at specific times within a growth cycle, such as at first sprouting, at a set height, before seed release, and at other times.

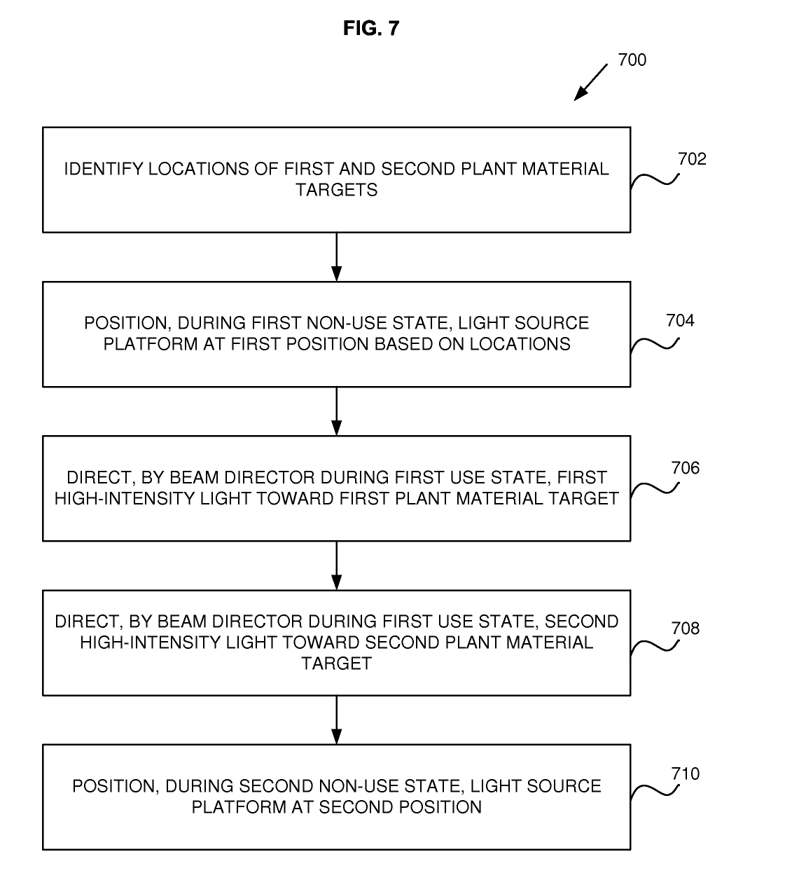

Turning to FIG. 7, a flow diagram illustrating a method of eradicating and controlling weeds 700 is shown according to one embodiment. In some embodiments, method 700 is implemented by one or more of apparatus 100, 200, 300, 400, 500, and 600. Method 700 is described below with respect to apparatus 100. However, method 700 may similarly be performed by other apparatus and systems.

At 702, the locations of plant material targets 102, 104 are identified. For example, the locations of plant material targets 102, 104 (e.g., weeds or weed seedpods) may be identified using various imaging and/or remote sensing techniques, such as image recognition, spectrometry, etc., on information captured by sensor 122.

At 704, during a first non-use state, light source platform 112 including light source 114 is positioned within field 106 in a first position based on the location of plant material targets 102, 104.

At 706, during a first use state following the first non-use state, first high-intensity light beam 116 from high-intensity light source 114 is directed by beam director 120 towards first plant material target 102. For example, in one embodiment, the control system (e.g., control system 500 of FIG. 5) may provide a control signal to beam director and/or light source 114 based on the locations identified at 702.

At 708, during the first use state, second high-intensity light beam 118 from high-intensity light source 114 is directed by beam director 120 towards second plant material target 104. For example, in one embodiment, the control system (e.g., control system 500 of FIG. 5) may provide a control signal to beam director and/or light source 114 based on the locations identified at 702.

At 710, during a second non-use state following the first non-use state, light source platform 112 including light source 114 is positioned at a second position. Accordingly, method 700 includes directing high-intensity light beams 116, 118 to separate plant material targets 102, 104 while light source platform 112 is fixed in a single location.

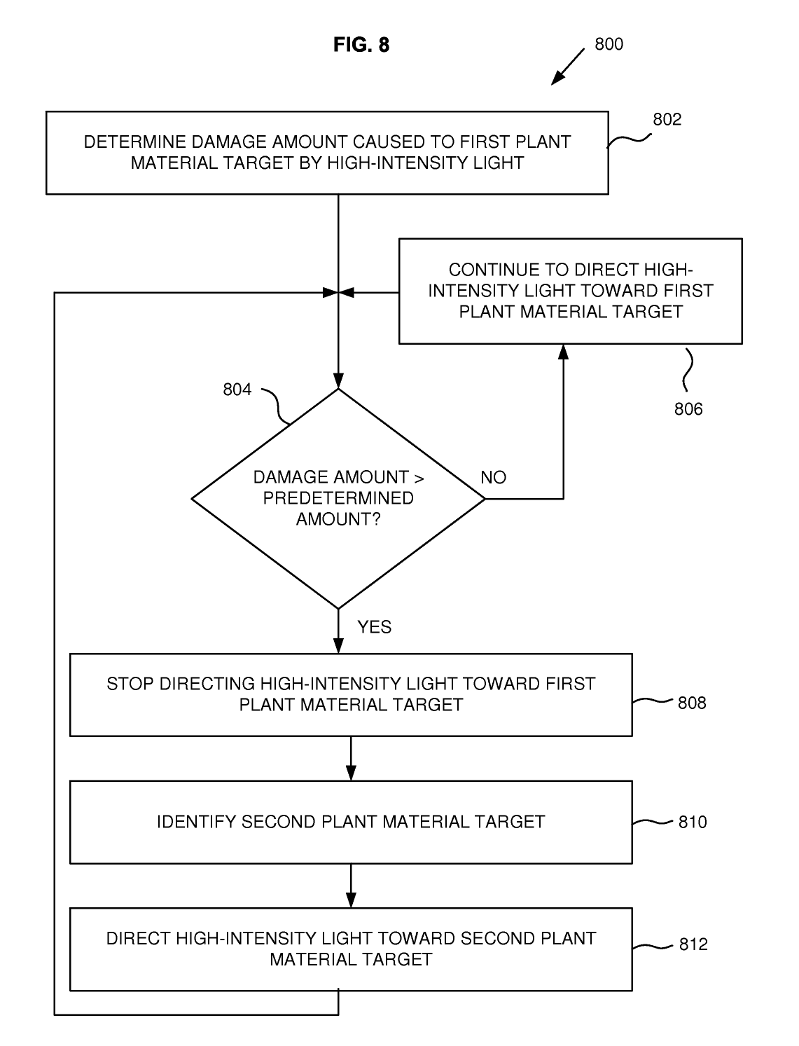

Turning to FIG. 8, a flow diagram illustrating a method of eradicating unwanted plants 800 is shown according to one embodiment. In some embodiments, method 800 is implemented by one or more of apparatus 100, 200, 300, 400, 500, and 600. The method 800 may be performed in conjunction with the method 700 of FIG. 7.

At 802, a damage amount caused to first plant material target 102 by high-intensity light beam 116 is determined. For example, the damage amount may be determined by performing various image processing techniques, such as image recognition, spectrometry, among others, on information captured by sensor 122. The damage amount may be a relative value used to quantify an amount of damage to first plant material target 102, and may be based on various factors, such as changes in color.

At 804, it is determined whether the damage amount determined at 802 exceeds a predetermined amount. According to an embodiment, the predetermined amount may indicate an amount of damage to first plant material target 102 to cause first plant material target 102 to die or to be incapable of reproduction, for example.

If at 804 it is determined that the damage amount does not exceed a predetermined amount, the method continues to 806. At 806, high-intensity light is continued to be redirected at first plant material target 102.

If it is instead determined at 804 that the amount of damage does exceed the predetermined amount, the method continues to 808. At 808, redirection of high-intensity light toward first plant material target 102 is stopped. In some embodiments, this is effected by stopping transmission of light beam 116 from high-intensity light source 114.

At 810, second plant material target 104 is identified. For example, second plant material target 104 may be identified using the same techniques as those used to identify first plant material target 102.

At 812, high-intensity light beam 118 is directed toward second plant material target 104. According to an embodiment, high-intensity light beam 118 may be configured to cause an amount of damage to second plant material target 104 to cause second plant material target 104 to die or to be incapable of reproduction, for example.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A plant material targeting apparatus, comprising:
a light source platform configured to be mobile during a non-use state and to remain at a fixed location during a use state;
a light source coupled to the light source platform, the light source configured to provide a high-intensity light;
a beam director configured to direct the high-intensity light at first and second plant material targets; and
a control system configured to receive information representative of the location of the first and second plant material targets, and configured to provide a control signal to the beam director to control aiming of the high-intensity light at each of the first and second plant material targets while the light source platform is at the fixed location.

2. The apparatus of claim 1, wherein the light source platform has a height, the height configured to change when switching from the non-use state to the use state.

3. The apparatus of claim 1, wherein the light source platform includes a mechanical stabilization that is deployed during the use state, the mechanical stabilization not used during the non-use state.

4. The apparatus of claim 1, wherein the light source includes a laser.

5. The apparatus of claim 4, wherein the laser includes at least one of a diode laser, a carbon dioxide (CO₂) laser, a fiber laser, and a diode-pumped solid state (DPSS) laser.

6-8. (canceled)

9. The apparatus of claim 1, wherein the plant material target includes a designated part of a weed.

10. The apparatus of claim 9, wherein the designated part of the weed includes a seedpod of the weed.

11. The apparatus of claim 1, wherein the control system is configured to determine a type of the plant material target.

12. The apparatus of claim 1, wherein the control system is configured to distinguish a plant material target from a predetermined plant material.

13. The apparatus of claim 1, wherein the control system is configured to control a height of the beam director.

14. (canceled)

15. The apparatus of claim 1, wherein the beam director includes a mirror train, the mirror train including at least two positionable mirrors.

16. The apparatus of claim 1, wherein the beam director includes optics configured to focus the high-intensity light toward the plant material target.

17. The apparatus of claim 1, wherein the light source platform is movable.

18-23. (canceled)

24. The apparatus of claim 1, wherein the control system is configured to control a height of the light source.

25-29. (canceled)

30. The apparatus of claim 1, further comprising a sensor configured to provide the information representative of the specified plant material target.

31-38. (canceled)

39. The apparatus of claim 1, further comprising an illumination light source separate from the high-intensity light source, the illumination light source configured to illuminate potential plant material targets.

40. The apparatus of claim 1, wherein the control system is switchable between a plant material damaging mode and a plant material targeting mode.

41. The apparatus of claim 40, wherein the plant material targeting mode includes at least one of multi-wavelength and broadband sensing.

42. The apparatus of claim 40, wherein the light source is configured to operate using higher power in the plant material damaging mode relative to the plant material targeting mode.

43. The apparatus of claim 41, wherein the plant material targeting mode includes determining and storing locations of a plurality of plant material targets, and wherein the plant material damaging mode includes damaging the plant material targets based on the stored locations of the plant material targets.

44. A method of eradicating unwanted plants, the method comprising:
identifying locations of first and second plant material targets;
positioning, during a first non-use state, a light source platform at a first position based on the location of the plant material targets, wherein each of high-intensity light source and a beam director are coupled to the light source platform;
directing, by the beam director during a first use state following the first non-use state, a first high-intensity light from the high-intensity light source toward the first plant material target;
directing, by the beam director during the first use state, a second high-intensity light from the high-intensity light source toward the second plant material target; and
positioning, during a second non-use state following the first use state, the light source platform including the high-intensity light source, at a second position.

45-49. (canceled)

50. The method of claim 44, wherein the plant material target includes a designated part of a weed.

51. The method of claim 50, wherein the designated part of the weed includes a seedpod of the weed.

52-57. (canceled)

58. The method of claim 44, wherein the beam director is a first beam director, and wherein the high-intensity light is directed towards the plant material target via a second beam director.

59. The method of claim 58, wherein at least one of the first and second beam directors includes a single positionable mirror.

60. The method of claim 58, wherein at least one of the first and second beam directors includes a mirror train, the mirror train including at least two positionable mirrors.

61. The method of claim 58, wherein at least one of the first and second beam directors includes optics configured to focus the high-intensity light toward the plant material target.

62. The method of claim 58, further comprising controlling a height of at least one of the first and second beam directors.

63. The method of claim 44, wherein positioning the light source platform includes controlling a height of the light source platform.

64. The method of claim 44, further comprising providing, by a sensor, the location of the plant material target.

65-72. (canceled)

73. The method of claim 44, further comprising switching between a plant material damaging mode and a plant material targeting mode.

74. The method of claim 73, further comprising:
using the plant material targeting mode to determine and store locations of a plurality of plant material targets; and
using the plant material damaging mode in accordance with the stored locations of the plant material targets.

75. The method of claim 44, further comprising determining whether the high-intensity light hit the plant material target.

76. The method of claim 44, further comprising determining a damage amount caused to the plant material target by the high-intensity light.

77. The method of claim 76, further comprising:
if the damage amount is less than a predetermined amount, continuing to cause redirection of the high-intensity light to the plant material target; and
if the damage amount is greater than the predetermined amount,
stopping redirection of the high-intensity light to the plant material target,
identifying a second plant material target, and
causing redirection of the high-intensity light to the second plant material target.
